(19) United States
(12) Patent Application Publication
(10) Pub. No.: US 2011/0200295 A1
(43) Pub. Date: Aug. 18, 2011

(54) EXEMPTION SCREEN DISPLAY DEVICE AND EXEMPTION SCREEN DISPLAY METHOD

(75) Inventor: Tomotaka IDA, Kumagaya-shi (JP)

(73) Assignee: KABUSHIKI KAISHA TOSHIBA, Tokyo (JP)

(21) Appl. No.: 12/911,512

(22) Filed: Oct. 25, 2010

(30) Foreign Application Priority Data
Feb. 18, 2010 (JP) 2010-033808

(51) Int. Cl. H04N 5/775

(52) U.S. Cl. 386/230; 386/E05.003

(57) ABSTRACT

According to one embodiment, an exemption screen display device includes a display module and a recording module. When utilization of a service using a communication function based on a network is requested, the display module displays an exemption clause for the requested service on the screen. When consent is given to the exemption clause displayed by the display module, the recording module records information on the consent to the exemption clause.

### CROSS-REFERENCE TO RELATED APPLICATIONS

This application is based upon and claims the benefit of priority from Japanese Patent Application No. 2010-033808, filed Feb. 18, 2010; the entire contents of which are incorporated herein by reference.

### FIELD

Embodiments described herein relate generally to improvement of an exemption screen display device and exemption screen display method configured to make it possible to display an exemption clause on a screen, and give consent to the exemption clause on the screen.

### BACKGROUND

As is generally known, in recent years, digitization of television broadcasting has been promoted. For example, in Japan, not only digital satellite broadcasting such as broadcasting satellite (BS) digital broadcasting and 110-degree communication satellite (CS) digital broadcasting, but also digital terrestrial broadcasting has already been put to practical use.

As a result of this, in a digital television broadcast receiver configured to receive such digital television broadcasting, a function of selectively receiving digital satellite broadcasting, and digital terrestrial broadcasting, in addition to existing analog terrestrial broadcasting is incorporated. Further, at present, in a digital television broadcast receiver of this kind, a network connection function is also incorporated.

By the incorporation of the network connection function, it becomes possible for the digital television broadcast receiver to access various service supply sites on the network, e.g., it becomes possible for the receiver to utilize various services using the communication function based on the network provided by a third party or the like.

Here, in order to utilize various services of this kind using the communication function based on the network, it is necessary for the user to consent to the exemption clause (for example, a disclaimer indicating in advance that there is the possibility of the service contents being suddenly changed, stopped, terminated or deleted without notice) for the service.

That is, when the user requires a desired service, information for displaying an exemption clause associated with utilization of the service is transmitted to the user from a service supply site providing the service, and is displayed on the screen. Further, it becomes possible for the user to utilize the service by carrying out an operation of consenting to the exemption clause displayed on the screen.

Incidentally, in the consent means of the exemption clause described above, under the current circumstances, information indicating whether or not consent has been given to the exemption clause for each of the services is not displayed. As a result of this, for example, when requesting a desired service, the user determines whether or not the user's consent has been given to the exemption clause with respect to the service on the basis whether or not the exempt clause is displayed or whether or not the service is carried out.

In Jpn. Pat. Appln. KOKAI Publication No. 2008-124683, it is disclosed that in a television device capable of receiving a digital broadcast, when the power is turned on in a state where an IC card for consent to use is inserted in a tuner module, a message prompting the user to read a receiver contract is displayed, and when the user operates switches in accordance with a releasing method described in the receiver contract, display of the message is stopped.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is a block configuration diagram shown to explain an example of an outline of a digital television broadcast receiver in one embodiment;

FIG. 2 is a view shown to explain an example of an external appearance of a remote controller of the digital television broadcast receiver in the embodiment;

FIG. 3 is a view shown to explain an example of a service selection screen to be displayed on the digital television broadcast receiver in the embodiment;

FIG. 4 shows views shown to explain examples of language selection on an exemption screen to be displayed on the digital television broadcast receiver in the embodiment;

FIG. 5 shows views shown to explain examples of exemption clause display on an exemption screen to be displayed on the digital television broadcast receiver in the embodiment;

FIG. 6 is a view shown to explain an example of an exemption consent-related information display screen to be displayed on the digital television broadcast receiver in the embodiment; and

FIG. 7 is a flowchart shown to explain an example of a main operation to be carried out by the digital television broadcast receiver in the embodiment.

### DETAILED DESCRIPTION

Various embodiments will be described hereinafter with reference to the accompanying drawings. In general, according to one embodiment, an exemption screen display device includes a display module and a recording module. When utilization of a service using a communication function based on a network is requested, the display module displays an exemption clause for the requested service on the screen. When consent is given to the exemption clause displayed by the display module, the recording module records information on the consent to the exemption clause.

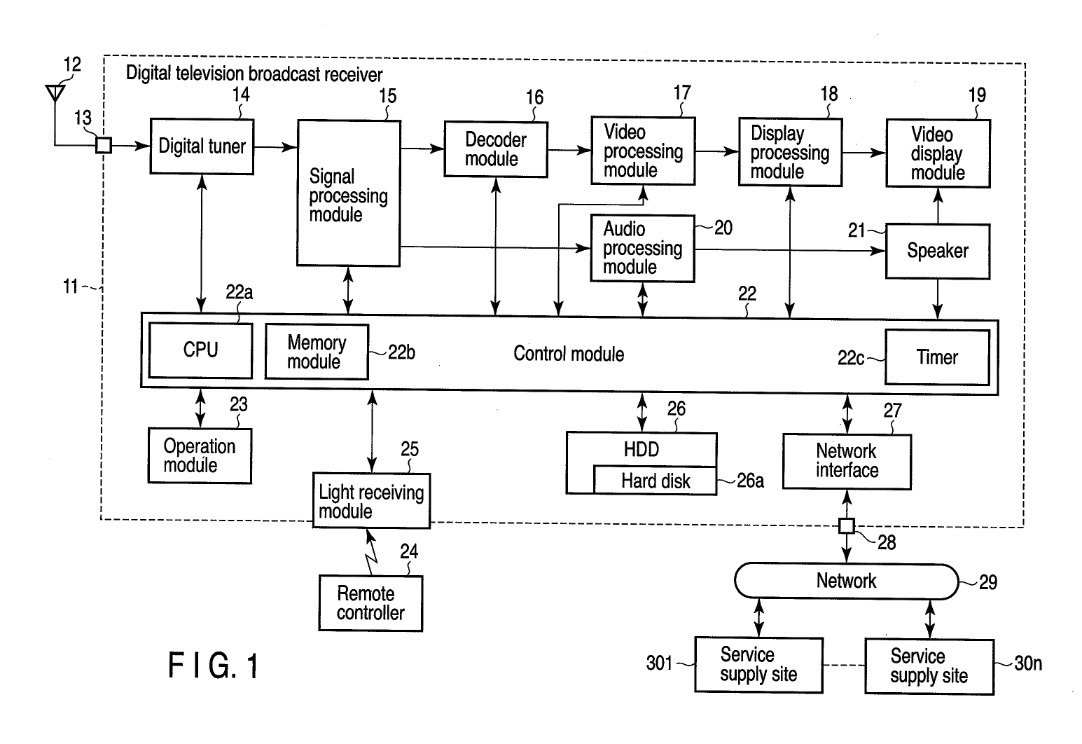

FIG. 1 shows an outline of a digital television broadcast receiver 11 to be explained in the embodiment. That is, a digital broadcast signal received by an antenna 12 is supplied to a digital tuner 14 through an input terminal 13, whereby the digital broadcast signal of a desired channel is selected.

The digital broadcast signal selected by the digital tuner 14 is supplied to a signal processing module 15, and is demodulated therein, whereby the signal is separated into a video signal and audio signal. Of the two signals, the video signal is supplied to a decoder module 16 to be subjected to decoding processing, and is thereafter supplied to a video processing module 17 to be subjected to predetermined digital signal processing such as screen size adjustment, and the like.

Further, the video signal output from the video processing module 17 is supplied to a display processing module 18, and graphic information such as character information, an On Screen Display (OSD) signal, and the like is superimposed thereon. Thereafter, the video signal on which the graphic information is superimposed by the display processing module 18 is supplied to a video display module 19 to be used for video display.

Further, the audio signal separated by the signal processing module 15 is supplied to a audio processing module 20, whereby the audio signal is subjected to predetermined audio signal processing, and is thereafter amplified. Further, the audio signal output from the audio processing module 20 is supplied to a speaker 21 to be used for audio reproduction.

Here, regarding the digital television broadcast receiver 11, all the operations thereof including the reception operation described above are controlled by a control module 22 in a unified manner. The control module 22 incorporates therein a Central Processing Unit (CPU) 22a, receives operating information obtained from an operation module 23 provided on a main body of the digital television broadcast receiver 11 or operating information transmitted from a remote controller 24, and received by a light receiving module 25, and controls each module so that the operation contents can be reflected.

In this case, the control module mainly utilizes a memory module 22b. The memory module 22b includes a Read Only Memory (ROM) in which a control program to be executed by the CPU 22a is stored, Random Access Memory (RAM) configured to provide a work area to the CPU 22a, and nonvolatile memory in which various setting information, control information, and the like are stored.

Further, an HDD 26 is connected to the control module 22. The control module 22 can carry out control in such a manner that a video signal obtained from the decoder module 16 and audio signal obtained from the audio processing module 20 are supplied to the HDD 26 to be recorded on a hard disk 26a on the basis of an operation of the operation module 23 or the remote controller 24 carried out by the user.

Furthermore, the control module can carry out control to cause the HDD 26 to read a video signal and audio signal from the hard disk 26a, and supply the read video signal and audio signal to the decoder module, and audio processing module 20, respectively, to be used for video display and audio reproduction on the basis of the operation of the operation module 23 or the remote controller 24 carried out by the user.

Further, a network interface 27 is connected to the control module 22. The network interface 27 is connected to an external network 29 through an input/output terminal 28. Further, a plurality of service supply sites 301, . . . , 30n configured to provide various services by utilizing a communication function through the network 29 are connected to the network 29.

As a result of this, the control module 22 can carry out information communication by accessing any one of the service supply sites 301, . . . , 30n through the network interface 27, input/output terminal 28, and network 29. That is, although details will be described later, when a desired service utilizing the communication function by the network 29 is requested by an operation of the remote controller 24 carried out by the user, the control module 22 accesses the service supply site (for example, 301) providing the service.

Then, when no consent has been given to the exemption clause for utilizing the requested service, the accessed service supply site 301 transmits information for causing the video display module 19 to display the exemption clause for the service to the control module 22. As a result of this, the control module 22 displays the exemption clause on the video display module 19 on the basis of the information received from the service supply site 301.

Further, when the user carries out an operation to consent to the exemption clause by using the remote controller 24, the consent information is supplied to the service supply site 301. Then, the service supply site 301 permits the control module 22 to carry out the requested service, and here it becomes possible for the digital television broadcast receiver 11 to utilize various services utilizing the communication function by the network 29.

Further, the control module 22 is provided with a timer 22c. Regarding the timer 22c, the user can set the time by operating the remote controller 24.

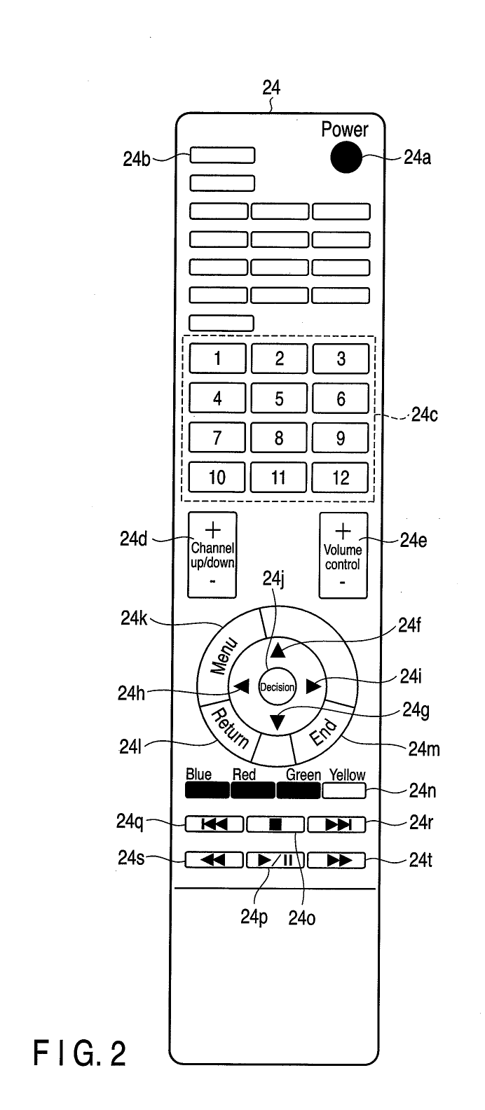

FIG. 2 shows the external appearance of the remote controller 24. The remote controller 24 is mainly provided with a power key 24a, service selection keys 24b, numeric keys 24c, channel up/down key 24d, volume control key 24e, cursor up key 24f, cursor down key 24g, cursor left key 24h, cursor right key 24i, decision key 24j, menu key 24k, return key 24l, end key 24m, and color keys of four colors (blue, red, green, yellow) 24n.

Further, the remote controller 24 is provided with a reproduction stop key 24o, reproduction/temporary stop key 24p, reverse skip key 24q, forward skip key 24r, fast reverse key 24s, and fast forward key 24t.

That is, regarding information such as video and audio acquired from the HDD 26, it becomes possible to carry out reproduction, stop, and temporary stop by operating the reproduction stop key 24o, and reproduction/temporary stop key 24p of the remote controller 24.

Further, it is possible to carry out so-called reverse skip or forward skip of skipping information such as video or audio being reproduced by the HDD 26 by a predetermined amount in the reverse or forward direction with respect to the reproduction direction.

Furthermore, by operating the fast reverse key 24s or fast forward key 24t, it is possible to carry out so-called fast reverse reproduction, or fast forward reproduction for continuously reproducing information such as video or audio being reproduced by the HDD 26 in the reverse or forward direction with respect to the reproduction direction.

An operation in the digital television broadcast receiver 11 described above of a case where the user requests a desired service from among various services provided by a plurality of service supply sites 301 to 30n will be described below in detail. That is, when requesting a desired service, the user operates the service selection key 24b of the remote controller 24.

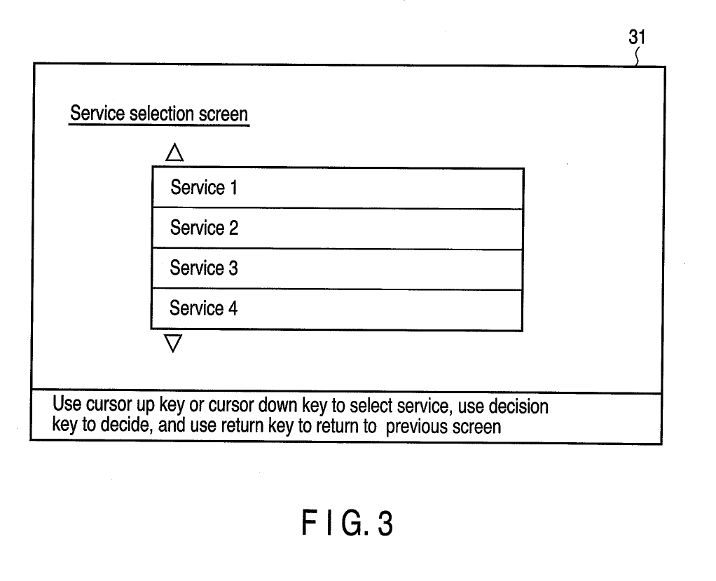

Then, the control module 22 displays a service selection screen 31 as shown in FIG. 3 as an example thereof on the video display module 19. On the service selection screen 31, various kinds (four kinds in the case shown in FIG. 3) of services, 1, 2, 3, and 4, provided by a plurality of service supply sites 301 to 30n which can be accessed by the control module are displayed in a list. It should be noted that on the service selection screen 31, other services 5, 6, can also be displayed in a scrolling manner by operating the cursor up key or cursor down key 24f or 24g of the remote controller 24.

Further, on the service selection screen 31, when the user operates the cursor up key or cursor down key 24f or 24g of the remote controller 24 to select a desired service 1 (for example, a widget or the like), and operates the decision key 24j, the control module 22 accesses a service supply site (for example, 301) and requests a service provided by the supply site.

At this time, when the user's consent has already been given to the exemption clause for utilizing the requested service, the accessed service supply site 301 provides the service so that the user can utilize the service.

Further, when no user's consent has yet been given to the exemption clause for utilizing the requested service, the accessed service supply site 301 transmits information for causing the video display module 19 to display the exemption clause for the service to the control module 22.

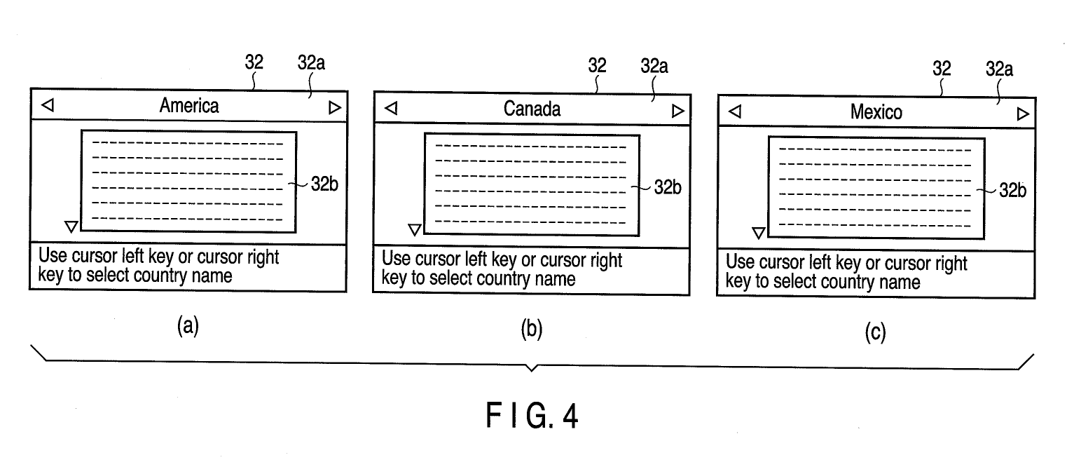

At this time, only when the digital broadcast signal received by the antenna 12 is acquired or information indicating the current time is acquired from the service supply site 301 from which the service is requested, the control module 22 displays an exemption screen 32 as shown by a reference symbol (a) of FIG. 4 as an example on the video display module 19 on the basis of the information received from the service supply site 301.

On the exemption screen 32 shown by the reference symbol (a) of FIG. 4, a country name display part 32a in which a country name (in this case, America) is to be displayed is provided at an upper end part of the screen, and an exemption clause display part 32b in which an exemption clause corresponding to the country displayed in the country name display part 32a in a language (in this case, English) of the displayed country is to be displayed is provided at the central part of the screen.

Further, in a state where the exemption clause screen 32 shown by the reference symbol (a) of FIG. 4 is displayed, when the user further operates the cursor right key 24i of the remote controller 24, the Canadian specification as shown by a reference symbol (b) of FIG. 4, i.e., an exemption screen 32 on which Canada is displayed in the country name display part 32a as the country name, and an exemption clause corresponding to Canada is displayed in the exemption clause display part 32b in the language of Canada is displayed.

Further, in a state where the exemption clause screen 32 shown by the reference symbol (b) of FIG. 4 is displayed, when the user further operates the cursor right key 24i of the remote controller 24, the Mexican specification as shown by a reference symbol (c) of FIG. 4, i.e., an exemption screen 32 on which Mexico is displayed in the country name display part 32a as the country name, and an exemption clause corresponding to Mexico is displayed in the exemption clause display part 32b in the language of Mexico is displayed.

Conversely, in a state where the exemption clause screen 32 of the Mexican specification shown by the reference symbol (c) of FIG. 4 is displayed, when the user operates the cursor left key 24h of the remote controller 24, the exemption screen 32 of the Canadian specification shown by the reference symbol (b) of FIG. 4 is displayed, and when the user further operates the cursor left key 24h of the remote controller, the exemption screen 32 of the American specification shown by the reference symbol (a) of FIG. 4 is displayed.

As described above, in the state where the exemption screen 32 is displayed on the video display module 19, the user can select an exemption screen 32 of the specification corresponding to the country in which the digital television broadcast receiver 11 is installed, and display the selected exemption screen 32 by operating the cursor left key or cursor right key 24h or 24i of the remote controller 24.

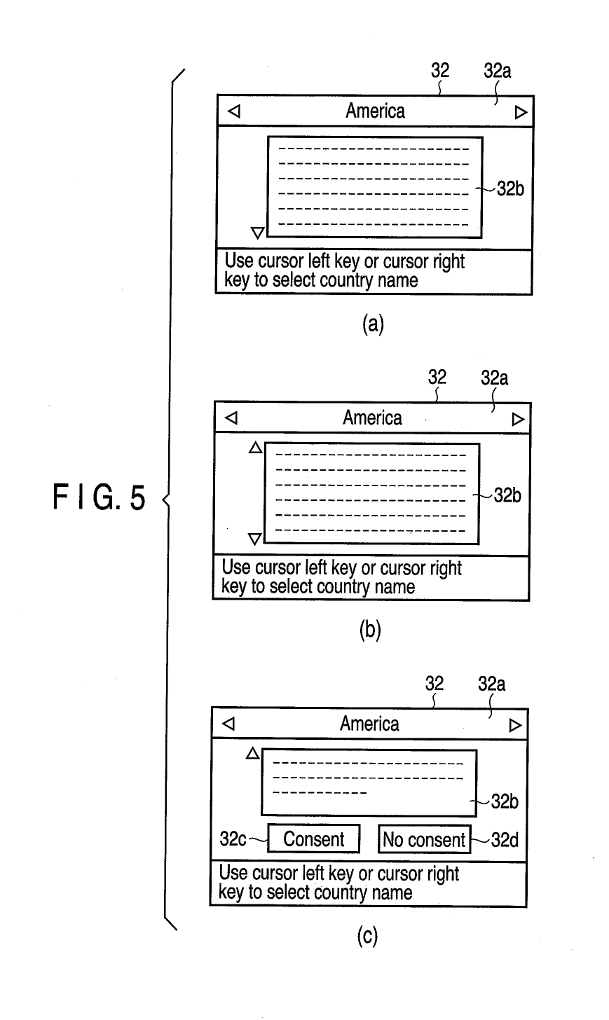

Now, for example, in the state where as shown by the reference symbol (a) of FIG. 5, the exemption screen 32 of the American specification is selected, and the beginning part of the exemption clause is displayed in the exemption clause display part 32b, when the user operates the cursor down key 24g, the exemption clause displayed in the exemption clause display part 32b is scrolled in the direction of the end of the sentence.

It should noted that in the state where the middle part of the exemption clause is displayed in the exemption clause display part 32b as shown by the reference symbol (b) of FIG. 5, when the user operates the cursor up key or cursor down key 24f or 24g, it is possible for the user to scroll the exemption clause displayed in the exemption clause display part 32b in the direction of the beginning or the end of the sentence.

Further, when the user operates the cursor down key 24g of the remote controller 24, the exemption clause is scrolled in the direction of the end of the sentence, and the end part of the sentence of the exemption clause is displayed in the exemption clause display module 32b as shown by the reference symbol (c) of FIG. 5, then an item 32c indicating “consenting” to the exemption clause, and item 32d indicating “not consenting” to the exemption clause are displayed on the exemption screen 32.

Thereafter, in the state where the end part of the sentence of the exemption clause is displayed in the exemption clause display part 32b, and further scrolling in the direction of the end of the sentence is stopped, when the user further operates the cursor down key 24g of the remote controller 24, the state where the item 32d indicating “not consenting” is automatically selected is obtained. When this state is obtained, when thereafter each time the user operates the cursor left key or cursor right key 24h or 24i, it is possible for the user to alternately select the item 32c indicating “consenting”, and item 32d indicating not “consenting”.

Further, when the user operates the cursor left key or cursor right key 24h or 24i to select the item 32c indicating “consenting”, and operates the decision key 24j, the user's consent is given to the exemption clause, and the consent information is supplied to the service supply site 301. As a result of this, the service supply site 301 permits the control module 22 to execute the requested service, and here it becomes possible for the digital television broadcast receiver 11 to utilize various services using the network function.

Here, when the user's consent is given to the exemption clause by the user, i.e., when the item 32c indicating “consenting” is selected, and the decision key 24j is operated, the control module 22 acquires various information items on the consent to the exemption clause including the fact that the user's consent has been given to the exemption clause, time at which the user's consent was given to the exemption clause, time elapsed from the giving of the user's consent to the exemption clause, number of times of utilization of the service after the giving of the user's consent to the exemption clause, current time, model name of the own device, i.e., model name of the digital television broadcast receiver 11, service to be utilized, i.e., software version of the service the exemption clause of which has obtained the user's consent, and records the acquired information items on, for example, the nonvolatile memory or the like of the memory module 22b.

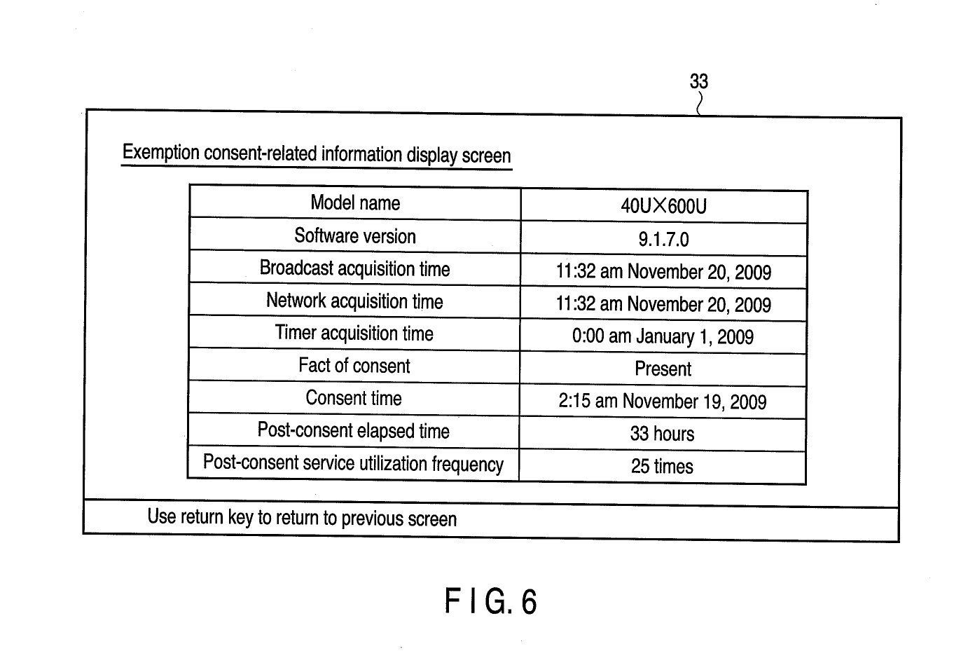

The recorded various information items associated with the consent to the exemption clause can be displayed on the video display module 19 by the request of the user. More specifically, when the user operates the menu key 24k of the remote controller 24 to make his or her way into a plurality of menu screens formed into the hierarchical structure, it is possible to realize the display by causing the video display module 19 to display an exemption consent-related information display screen 33 as shown in FIG. 6 as an example.

On the exemption consent-related information display screen 33, information “40UX600U” indicative of the model name of the own device, i.e., digital television broadcast receiver 11, and information “9. 1. 7. 0” indicative of the software version of the service to be utilized, i.e., the service the exemption clause of which has obtained the user's consent are displayed.

Further, on the exemption consent-related information display screen 33, information “11:32 am Nov. 20, 2009” indicative of the broadcast acquisition time which is the current time acquired from the received digital broadcast signal, information “11:32 am Nov. 20, 2009” indicative of the network acquisition time which is the current time acquired from the service supply site 301, and information “0:00 am Jan. 1, 2009” indicative of the timer acquisition time which is the current time acquired from the timer 22c are displayed.

Furthermore, on the exemption consent-related information display screen 33, information “present” indicative of the fact that the user's consent has been given to the exemption clause, information “2:15 am Nov. 19, 2009” indicative of the consent time which is the time at which the user's consent has been given to the exemption clause, information “33 hours” indicative of the post-consent elapsed time which is the time elapsed from the giving of the user's consent to the exemption clause, and information “25 times” indicative of the post-consent service utilization frequency which is the number of times of utilization of the service from the giving of the consent to the exemption clause to the present time are displayed.

In this case, regarding the consent time, the network acquisition time is set with top priority, and the priority order is determined in such a manner that when the network acquisition time cannot be obtained, the consent time is set on the basis of the broadcast acquisition time. It should be noted that in the state where both the network acquisition time and broadcast acquisition time have already been acquired, it is also possible to record both the consent time based on the network acquisition time, and consent time based on the broadcast acquisition time, and display both types of consent time on the exemption consent-related information display screen 33.

Further, it is also possible to record all of the consent time based on the network acquisition time, consent time based on the broadcast acquisition time, and consent time based on the timer 22c acquisition time, and display all three types of consent time on the exemption consent-related information display screen 33.

Furthermore, as described previously, in the state where both the network acquisition time, and broadcast acquisition time cannot be obtained, the control module 22 operates to stop displaying the exemption screen 32 on the video display module 19 on the basis of the information received from the service supply site 301. That is, in the state where both the network acquisition time, and broadcast acquisition time cannot be obtained, the exemption screen 32 is not displayed, and hence the configuration is made in such a manner that the service cannot be utilized.

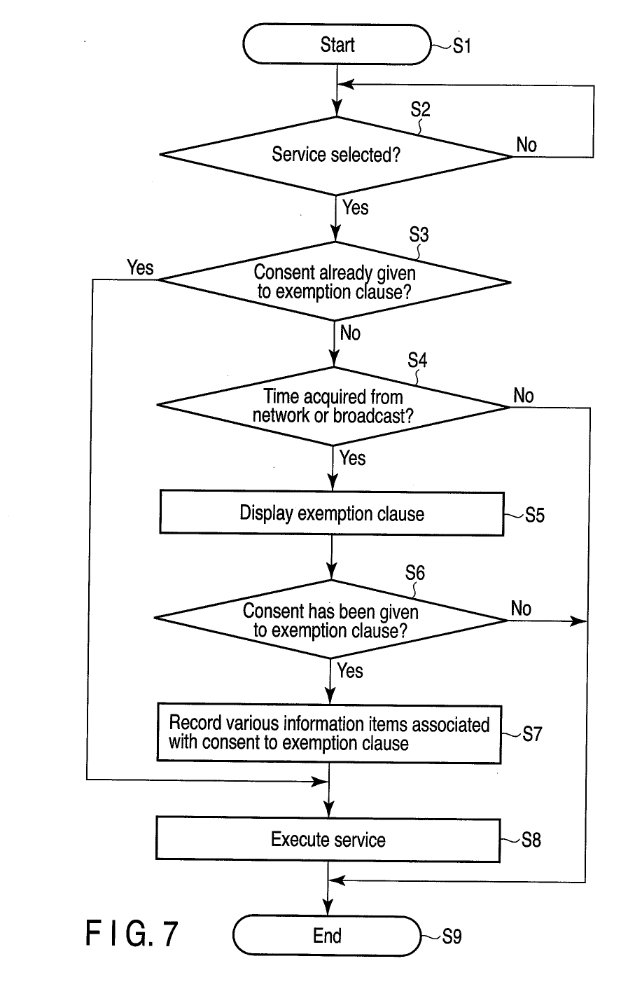

FIG. 7 shows a flowchart in which a series of processing operations for recording various information items associated with consent to the exemption clause when the consent is given to the exemption clause, and displaying the recorded information items are summarized. That is, when the processing is started (step S1), the control module 22 determines in step S2 whether or not any one of services provided by a plurality of service supply sites 301 to 30n has been selected.

Further, when it is determined that a service has been selected (YES), the control module 22 determines in step S3 whether or not consent has already been given to an exemption clause for the selected service by referring to, for example, already recorded various information items associated with consents to exemption clauses. Here, when it is determined that consent has not yet been given to the exemption clause (NO), the control module 22 determines in step S4 whether or not at least one of the network acquisition time and broadcast acquisition time has been acquired.

When it is determined that at least one of the network acquisition time and broadcast acquisition time has been acquired (YES), the control module 22 accesses a service supply site (for example, 301) providing the selected service in step S5, acquires information for displaying an exemption clause, and displays the exemption clause on the video display module 19.

Thereafter, the control module 22 determines in step S6 whether or not consent has been given to the exemption clause by the user, and when it is determined that consent has been given to the exemption clause (YES), the control module 22 transmits information indicating that the consent has been given to the exemption clause to the service supply site (for example, 301), and records, in step S7, various information items associated with the consent to the exemption clause on the nonvolatile memory of the memory module 22b.

After step S7 or when it is determined in step S3 that consent has already been given to the exemption clause for the selected service (YES), the control module 22 accesses the service supply site (for example, 301) in step S8 to execute the service provided by the service supply site, and terminates the processing (step S9).

When it is determined in step S4 that both the network acquisition time and broadcast acquisition time have not been acquired yet (NO) or when it is determined in step S6 that no consent has been given by the user to the exemption clause (NO), the control module 22 terminates the processing (step S9).

According to the embodiment described above, when the user's consent is given by the user to the exemption clause for the service to be utilized, it is made possible to record and display various information items associated with the consent to the exemption clause including the time at which the consent has been given, and hence it becomes easily possible to carry out post pursuit associated with consenting to the exemption clause by the user, this being suitable for practical use.

Further, in the embodiment described above, although the user operates the remote controller 24 to display the exemption consent-related information display screen 33, the example is not limited this. For example, it is also possible to cause the exemption consent-related information display screen 33 to be compulsorily displayed at the point at which the user gives the user's consent to the exemption clause. In this case, it is possible for the exemption consent-related information display screen 33 to be displayed only for a predetermined time or until the return key 24l of the remote controller is operated.

Furthermore, in the embodiment described above, when the user selects a service, the control module 22 accesses the service supply site (for example, 301) providing the service, acquires information for displaying the exemption clause from the site, and causes the video display module 19 to display the exemption clause.

Conversely, for example, it is also conceivable that with respect to a plurality of service supply sites 301 to 30n which the control module 22 can access, information for displaying the exemption clause for the service provided by each of the service supply sites is stored in the memory module 22b for each country. By doing so, when the user selects a desired service, it is possible to read the information for displaying the exemption clause corresponding to the service from the memory module 22b, and display the information on the video display module 19.

Further, when it is determined by the control module 22 that the user's consent has been given to the exemption clause, it becomes possible to utilize the service only after the control module 22 accesses the service supply site (for example, 301) for the first time, and hence the number of times of accessing a service supply site (for example, 301) is reduced, thereby making it possible to carry out efficient information transmission.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An exemption screen display device comprising:
a display module configured to display an exemption clause for a requested service on a screen in response to a request to utilize the service using a communication function based on a network; and
a recording module configured to record information associated with consent to the exemption clause in response to an entry of consent to the exemption clause displayed by the display module.

2. The exemption screen display device of claim 1, wherein
the recording module is configured to record the time at the entry of the consent as information associated with the consent to the exemption clause.

3. The exemption screen display device of claim 1, wherein
the recording module is configured to record the time at the entry of the consent as information associated with the consent to the exemption clause by using time information acquired through the network.

4. The exemption screen display device of claim 1, wherein
the recording module is configured to record the time at the entry of the consent to the exemption clause as information associated with the consent to the exemption clause by prioritizing the time of the entry of consent over time information acquired from a received broadcast signal by using time information acquired through the network.

5. The exemption screen display device of claim 1, wherein
the recording module is configured to record the time at the entry of the consent as information associated with the consent to the exemption clause in three manners, respectively, by using time information acquired through the network, time information acquired from a received broadcast signal, and time information acquired from a timer incorporated in the device.

6. The exemption screen display device of claim 1, wherein
the recording module is configured to record at least one of the time elapsed from the entry of the consent to the present time, and the number of times of utilization of the service from the entry of the consent to the present time, as information associated with the consent to the exemption clause.

7. The exemption screen display device of claim 1, wherein
the display module is configured to disable displaying the exemption clause on the screen if time information from the network and time information from a received broadcast signal cannot be acquired.

8. The exemption screen display device of claim 1, further comprising a control module configured to display the recorded information on the screen when the information associated with the consent to the exemption clause is recorded on the recording module.

9. An exemption screen display method comprising:
displaying an exemption clause for a requested service on a screen in response to a request to utilize the service using a communication function based on a network; and
recording information associated with consent to the exemption clause in response to an entry of consent to the displayed exemption clause.
